(19) United States
(12) Patent Application Publication
(10) Pub. No.: US 2025/0061303 A1
(43) Pub. Date: Feb. 20, 2025

(54) LARGE LANGUAGE MODEL ASSISTED SEMANTIC WEB KNOWLEDGE BASE

(71) Applicant: Halliburton Energy Services, Inc., Houston, TX (US)

(72) Inventors: Lu Sun, Singapore (SG); Xiang Wu, Singapore (SG); Robert P. Darbe, Houston, TX (US); Ketan C. Bhaidasna, Houston, TX (US)

(21) Appl. No.: 18/451,959

(22) Filed: Aug. 18, 2023

(51) Int. Cl. G06N 3/042; E21B 44/00; G05B 13/02; G06N 3/0455; G06N 3/096

(52) U.S. Cl. CPC G06N 3/042; E21B 44/00; G05B 13/027; G06N 3/0455; G06N 3/096

(57) ABSTRACT

A system and method for accessing drilling records. A semantic web for drilling records is built, wherein building includes converting drilling records retrieved from a database into a Resource Description Framework (RDF) format and storing the RDF formatted drilling records in the semantic web. Transfer learning is applied to drilling domain knowledge to obtain a large language model (LLM) with drilling domain knowledge. A schema is applied to unstructured records to extract information from unstructured records and the extracted information is then stored in RDF format to the semantic web. The LLM is configured to query the semantic web and to manipulate RDF formatted data within the semantic web.

### BACKGROUND

As part of hydrocarbon recovery operations, a wellbore can be formed in a subterranean formation for extracting produced hydrocarbon material or other suitable material. The wellbore may experience or otherwise encounter one or more wellbore operations such as drilling the wellbore. Drilling, or otherwise forming, the wellbore can involve using a drilling system that can include a drill bit and other suitable tools or components for forming the wellbore. During drilling, the drilling system may change the course (e.g., speed, direction, etc.) of the drill bit to form a wellbore that may not be purely vertical.

### BRIEF DESCRIPTION OF THE DRAWINGS

Embodiments of the disclosure may be better understood by referencing the accompanying drawings.

FIG. 1 is an elevation view in partial cross section of an example well system that supports directional drilling, according to aspects of the present disclosure.

FIG. 2 is a block diagram illustrating an example large language model (LLM) assisted semantic web knowledge base.

FIG. 3 is a timeline illustrating evolution of the knowledge base of FIG. 2.

FIG. 4 is a block diagram illustrating an example system for querying the large language model assisted semantic web knowledge bases of FIGS. 2 and 4.

FIG. 5 is a block diagram illustrating an example autonomous drilling controller for querying the large language model assisted semantic web knowledge bases of FIGS. 2 and 4.

FIGS. 6A-6C illustrate parts of a schematic design of a semantic web such as the semantic webs of FIGS. 2-5.

FIG. 7 is a flowchart illustrating a method of applying the large language model assisted semantic web knowledge bases of FIGS. 1-5.

FIG. 8 is a flowchart illustrating a method of guiding a platform drilling controller with an LLM assisted semantic web knowledge base such as the LLM assisted semantic web knowledge bases of FIGS. 1-5.

Like reference numbers and designations in the various drawings indicate like elements.

### DETAILED DESCRIPTION

The description that follows includes example systems, methods, techniques, and program flows that embody embodiments of the disclosure. Unless otherwise specified, use of the terms “connect,” “engage,” “couple,” “attach,” or any other like term describing an interaction between elements is not meant to limit the interaction to a direct interaction between the elements and may also include an indirect interaction between the elements described. Unless otherwise specified, use of the terms “up,” “upper,” “upward,” “uphole,” “upstream,” or other like terms shall be construed as generally away from the bottom, terminal end of a well: likewise, use of the terms “down,” “lower,” “downward,” “downhole,” or other like terms shall be construed as generally toward the bottom, terminal end of the well, regardless of the wellbore orientation. Use of any one or more of the foregoing terms shall not be construed as denoting positions along a perfectly vertical axis. In some instances, a part near the end of the well can be horizontal or even slightly directed upwards. Unless otherwise specified, use of the term “subterranean formation” shall be construed as encompassing both areas below exposed earth and areas below earth covered by water such as ocean or fresh water.

As noted above, drilling operations may introduce a change in the operation (e.g., speed, direction, etc.) of the drill bit to change the trajectory of the drill string, forming a wellbore that may not be purely vertical. Doglegs, sections of a borehole where the trajectory changes rapidly, are an integral part of drilling. Thoughtfully planned and drilled, doglegs are part of an optimized borehole, avoiding problematic formations and maintaining the right drilling angle to reach a desired zone. Many factors, however, influence whether the dog leg location and curvature are appropriate or undesirable.

Operating parameters such as weight on bit (WOB), rotations per minute (RPM) of the bit, and flowrate may be adjusted in real time to steer a drill string. For example, the operating parameters may be adjusted to increase or decrease the dogleg capability of the drill string. At the same time, however, operating parameters (such as WOB, RPM, and flowrate) may be adjusted to maximize the rate of drilling, to manage a safe operating envelope and for telemetry and data transmission.

The mechanism by which parameters such as WOB, RPM, and flowrate individually impact the steering action is not understood. In addition, there is no comprehensive physics-based model that relates the influence of these controllable drilling parameters to dogleg severity (DLS). Instead, current practice often relies on the intuition and experience of the directional drillers to drive the change in these parameters for steering direction and efficiency. It can be very helpful to look at similar drilling operations when planning a new well and when addressing problems that arise in drilling the new well.

Certain aspects and features of the present disclosure relate to a bottom hole assembly (BHA) having a steering mechanism connected to a drill bit through a tool string, the drill bit for drilling into a subterranean formation to form a wellbore for extracting produced hydrocarbons. The steering mechanism may include a rotary steering system (RSS) including a steering collar and one or more pad actuators. In some examples, the steering collar may be a frame of the tool string, stiffening the tool string. In some examples, the pad actuators may be mounted on the steering collar to exert force on the side of a wellbore to change the direction of drilling while forming the wellbore.

Drilling companies accumulate information every time they drill a well. The information is recorded, for example, as a drilling report for each well, or is stored as data in a relational database. The data may include information from the drilling report or may be limited to copies or other representations of the drilling report. Older drilling reports may be limited to paper copies stored in a filing cabinet. It can, therefore, be difficult to access the accumulated information from drilling operations and to leverage the accumulated information to aid in making decisions while drilling new wells.

For automated drilling, the drilling controller may require the ability to identify the status and performance level of drilling, detect abnormalities, if any, to analyze contributing factors to the abnormalities detected and to offer suggestions and decisions accordingly. A powerful and scalable knowledge base gathers domain knowledge as well as past drilling records. In some example approaches, the knowledge base is both human and machine readable, and, in some such example approaches, the knowledge base includes logic reasoning (i.e., can derive unknown information from known information via the logics).

A method of informing decision making by operators and automated controllers while planning and executing drilling operations is described below. The method applies domain knowledge to the information recorded from previous drilling operations, responding to natural language and machine language queries in real time. The described knowledge base elevates the autonomous level of the drilling and provides useful suggestions to the drillers to achieve better drilling performance and efficiency.

To elevate drilling automation, an autonomous drilling controller may identify the status and performance level of the drilling and detect abnormalities, if any. The autonomous drilling controller may then analyze the contributing factors to the abnormality and make suggestions and decisions to address the abnormality accordingly. In one example approach, the autonomous drilling controller may make such suggestions and decisions based on a powerful and scalable knowledge base that gathers domain knowledge as well as past drilling records. In one such example approach, the knowledge base is both human and machine readable, and may perform logical reasoning, i.e., may derive unknown information from known information using logic.

In one example approach, the knowledge base supports site operations beyond autonomous drilling. The knowledge base relies on both domain knowledge and past records, such as formation detection, vibration detection, etc.

In one example approach, the knowledge includes both domain knowledge and past drilling records. The knowledge base is editable and scalable online. That is, there is no black-out period during scaling up of the knowledge base and knowledge base scaling up can be done automatically without human interaction.

In one example approach, past drilling records are stored in both human and machine-readable form. In one such example approach, the knowledge base has an application programming interface (API) for machines, and a natural language interface for humans. The knowledge base suggests optimal or near optimal operations and may respond to queries from both autonomous drilling controllers and site engineers and drillers.

In one example approach, the knowledge base analyzes the current drilling operation and suggests changes to the current drilling operation. In some such example approaches, the knowledge base relies on logics reasoning to derive unknown information from known knowledge.

The knowledge base is aware of the knowledge boundary about past drilling records and does not produce misinformation.

For example, with the help of the knowledge base, the performance of the current drilling is in real time compared with similar drillings in the same region what uses similar drilling tools. Abnormalities such as drilling inefficiency may be spotted. Using its domain knowledge, together with past drilling reports, the knowledge base may analyze the most likely contributing factors to the performance of the drilling and give operational suggestions to the drillers. This helps with making more consistent, reliable and “data-supported” decisions.

The same applies to autonomous drilling. By comparing the current drilling data with past drilling records, and using the domain knowledge, the knowledge base can detect events such as vibrations or formation changes and advise the control system to perform accordingly. In some example approaches, an autonomous drilling controller operates in a closed loop with sensors in a bottom hole assembly to determine and react to current drilling parameters.

The above eventually elevates both drill operator decision making and autonomous drilling to a higher level, which makes drilling more cost-effective and at the same safer and the performance better and more consistent. The insights captured by the knowledge base, since it is both human and machine readable, can be used for further analysis or training.

This disclosure includes illustrative examples used to introduce the reader to the general subject matter discussed herein: the examples are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

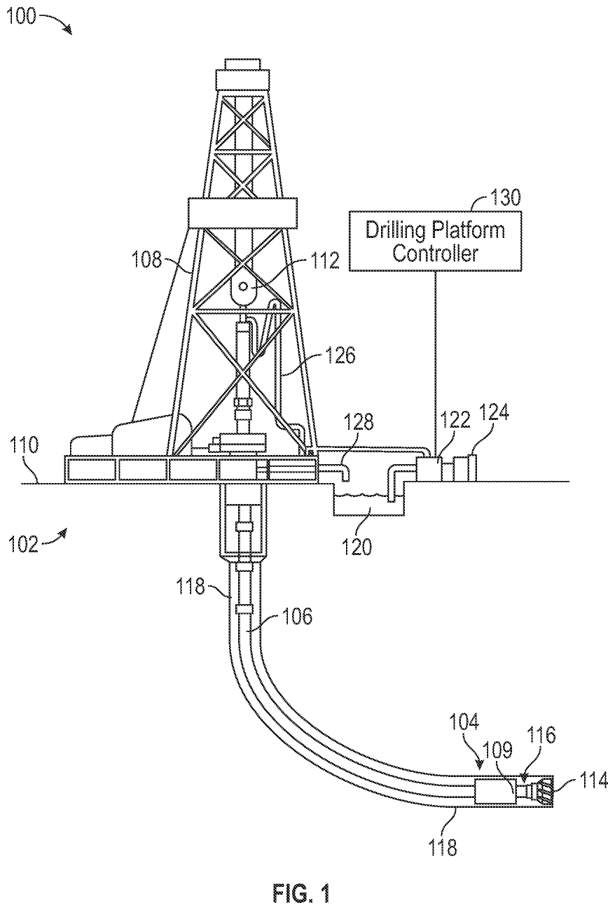

FIG. 1 is an elevation view in partial cross section of an example well system that supports directional drilling, according to aspects of the present disclosure. In the example shown in FIG. 1, the well system 100 directs a drill bit 114 in drilling a wellbore 118 through a subterranean formation 102, such as a subsea well or a land well. Example embodiments are not limited to only drilling an oil well. Some implementations may also encompass natural gas wellbores, other hydrocarbon wellbores, or wellbores in general. Further, some implementations may be used for the exploration and formation of geothermal wellbores intended to provide a source of heat energy instead of hydrocarbons.

In the example shown in FIG. 1, well system 100 includes a drill string 106 attached to a derrick 108 and a bottom hole assembly (BHA) 104: the BHA 104 may be positioned or otherwise arranged at the bottom of the drill string 106. The derrick 108 may be located at the surface 110 and may, in some example approaches, include a kelly 112 connected to drill string 106; the kelly 112 may be used, for instance, to lower and raise the drill string 106.

The BHA 104 may include a drill bit 114, a rotary steerable system 109, other suitable components, or a combination thereof. The drill bit 114 may, in some examples, be operatively coupled to a tool string 116, with the tool string 116 attached to the drill string 106 such that the drill bit 114 may be moved axially within drilled wellbore 118. During operation, the drill bit 114 can penetrate the subterranean formation 102 to extend the wellbore 118.

The BHA 104 may control the drill bit 114 as the drill bit 114 advances into the subterranean formation 102. For example, the BHA 104 may use the rotary steerable system 109 to change a direction of drilling by applying a steering pressure or other suitable force to a wall of the wellbore 118.

In the example shown in FIG. 1, fluid such as a drilling mud may be pumped downhole from a mud tank 120 using a mud pump 122 that may be powered by an adjacent power source, such as a prime mover (or motor) 124. The mud may be pumped from the mud tank 120, through a standpipe 126, which feeds the mud through the drill string 106 to the rotary steerable system 109, or other suitable components of the well system 100, and on to the drill bit 114. The mud may, in some examples, exit one or more nozzles (not shown) arranged in the drill bit 114 and may thereby cool the drill bit 114. Additionally or alternatively, the mud may be directed (e.g., as pressurized mud) into the rotary steerable system 109 for adjusting a direction of the drill bit 114, as discussed in further detail below.

After exiting the drill bit 114 or other suitable components, the mud may circulate back to the surface 110 via an annulus defined between the wellbore 118 and the drill string 106. The returning mud transports cuttings from the wellbore 118 into the mud tank 120 and aids in maintaining the integrity of the wellbore 118. For example, cuttings and mud mixture passed from the annulus through the flow line 128 may be processed such that a cleaned mud is returned down hole through the standpipe 126.

In some examples, the rotary steerable system 109 may include a steering collar, one or more actuation cylinders, and a radial seal for each cylinder. The steering collar may be designed to provide a rigid frame for the rotary steerable system 109. In one example approach, each actuation cylinder is mounted in a pocket of the steering collar, with a radial seal installed between each actuation cylinder and the steering collar: the radial seal forms a pressure seal or other suitable type of seal for each actuation cylinder in the rotary steerable system 109. In one such example approach, the radial seal allows the rotary steerable system 109 to receive pressure (e.g., via pressurized mud) used to apply the steering force without incurring damage, obstruction, excessive wear, or other related undesirable effects from the pressure. In one example approach, a piston positioned in each actuation cylinder may be used to apply the steering pressure or other suitable forces to the wall of the wellbore.

The tool string 116 may include one or more logging while drilling (LWD) or measurement-while-drilling (MWD) tools that collect data and measurements relating to various borehole and formation properties as well as the position of the drill bit 114 and various other drilling conditions as the drill bit 114 extends the wellbore 118 through the formations 102. The LWD/MWD tools may include a device for measuring formation resistivity, a gamma ray device for measuring formation gamma ray intensity, devices for measuring the inclination and azimuth of the tool string 116, pressure sensors for measuring drilling fluid pressure, temperature sensors for measuring borehole temperature, etc.

In one example approach, well system 100 includes a drilling platform controller 130 connected to mud pump 122. Drilling platform controller 130 receives drilling parameters from the drilling operation and determines changes to be made to the drilling parameters based on the knowledge base and on the current drilling parameters. In some example approaches, drilling platform controller 130 is communicatively connected to LWD/MWD tools and receives one or more drilling parameters from the LWD/MWD tools. In some such example approaches, drilling platform controller 130 is communicatively connected to an RSS 109 and modifies a drilling direction via RSS 109. In some example approaches, drilling platform controller 130 includes an autonomous drilling controller, as detailed below.

In the example shown in FIG. 1, RSS 109 is configured to change the direction of the tool string 116 and/or the drill bit 114, such as based on information indicative of tool orientation and a desired drilling direction received from a drilling application. In one or more embodiments, the RSS 109 is coupled to the drill bit 114 and may drive rotation of the drill bit 114. Specifically, the RSS 109 may rotate in tandem with the drill bit 114 or may rotate at a fraction of the rate of drill bit 114. In some implementations, the rotary steerable tool 109 may be a point-the-bit system or a push-the-bit system.

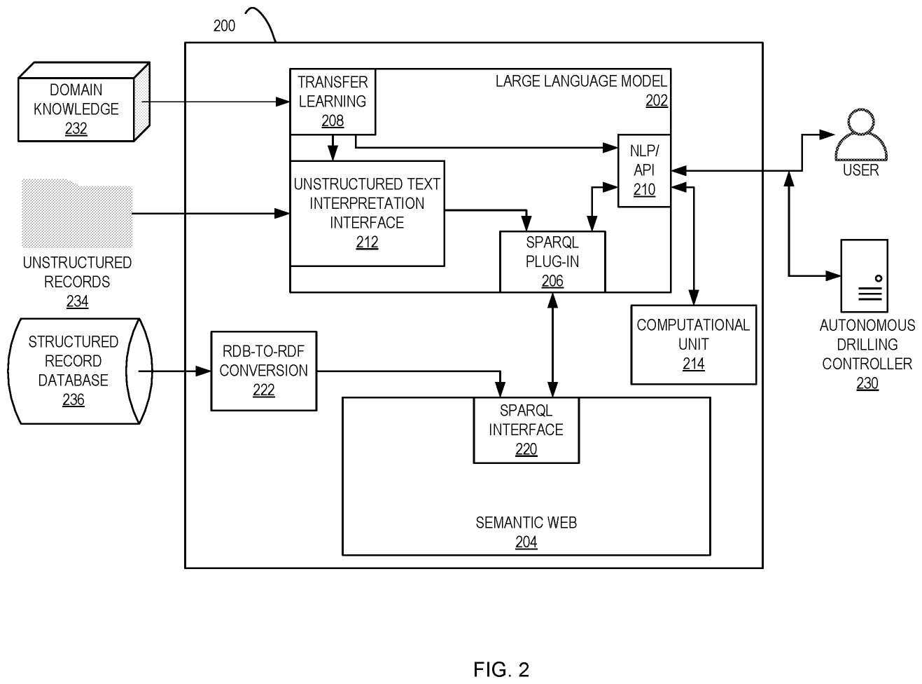

FIG. 2 is a block diagram illustrating an example large language model (LLM) assisted semantic web knowledge base. In the example of FIG. 2, knowledge base 200 includes a large language model (LLM) 202 connected to a semantic web 204. In some example approaches, as shown in FIG. 2, knowledge base 200 also includes a computational unit 214 connected to the LLM 202. In some such example approaches, computational unit 214 directly interacts with the LLM 202 to boost its computational capability. The combination of the large language model 202 with the semantic web 204 produces a large language model assisted semantic knowledge base capable of solving complex drilling problems.

LLMs have become increasingly popular. They are known for the ability to learn from unstructured text and from domain knowledge, to support natural language (and to respond to a human query), and to enable code generation and plug-ins, making it possible for LLM to directly communicate with other software. A knowledge base that combines LLM 202 with semantic web 204, as shown in FIG. 2, may, in one example approach, perform natural language queries and answer domain knowledgeable questions. The LLM 202 is further able to access the semantic web 204 to form query requests, and to return, explain, or summarize the query results to the user. In one example approach, the LLM includes an application program interface (API) API 210 that may be used by a drilling platform controller 130, such as a drilling controller under user control, or an autonomous drilling controller 230.

In one example approach, computational unit 214 is a collection of functions that boost the computational capability of the knowledge base 200. Examples of these functions include calculating the statistical characteristics of variables or applying filtering to signals. In some such example approaches, computational unit 214 communicates with the LLM 202 via the aforementioned API 210. In one example approach, when the LLM 202 requires computational processing of the data after retrieving the data from semantic web 204, LLM 202 triggers the computational unit 214 to do the calculation. Once the data is processed, it can consequently be returned to the user, the autonomous drilling controller 230 or written back to the semantic web 204 for future queries.

Semantic webs are an important concept detailed in the Web 3.0 framework for effective and efficient information gathering. Semantic web is known for its capability to store knowledge in both machine and human readable manner, to scale up easily without interrupting the existing parts of the network, to support logics reasoning (i.e., descriptional logic, using resource description framework (RDF), RDF schema (RDFS), and web ontology language frameworks), and to be self-aware of the knowledge boundary. In one example approach, RDF is a directed, labeled graph data format for representing data in semantic web 204.

Semantic webs 204 gather information quickly and efficiently, and drilling platform controller 130 does not need to know the schematic of the knowledge to conduct a query. (This is an advantage of semantic web over traditional relational databases.) In some example approaches, semantic web 204 includes logics reasoning, providing more insights in queries than traditional databases. And semantic web 204 is auto-scaling. That is, new records can be stored in the knowledge base automatically.

In the example shown in FIG. 2, semantic web 204 is used to store past drilling records. In some example approaches, semantic web 204 continuously is updated as new drilling records become available, continuously scaling up semantic web 204. Semantic web 204 is essentially a graph-based NoSQL database framework. The media that stores the data is known as an RDF model. Stored information comes from both structured data (e.g., an existing database) and unstructured drilling reports. RDF models support descriptional logic reasoning, meaning that semantic web 204 can derive unknown new knowledge from existing knowledge using logic inference.

In one example approach, semantic web 204 stores knowledge in a “triples” format of “object+predicate+subject”. Examples include:
:Run0200:hasStartDepth 1500.S““xsd:decimal”, and
:Run0200:hasStopDepth 3500.8““xsd:decimal”,
   making each entry both machine and human readable, and scalable. Semantic web 204 defines a schema of the elements using sub classes and sub properties. It uses the SPARQL (the name is derived from SPARQL Protocol and RDF Query Language) language to query and manipulate (insert, edit, delete) elements in the database. It is deterministic, meaning that the information it produces for a query is accurate.

Further information on semantic web may be found in Berners-Lee, T., Hendler, J. and Lassila, 0., 2001. The semantic web. Scientific American, 284 (5), pp. 34-43 and in Shadbolt, N., Berners-Lee, T. and Hall, W., 2006. The semantic web revisited. IEEE intelligent systems, 21 (3), pp. 96-101, the descriptions of which are incorporated herein by reference.

In the Semantic Web domain, the overall process usually includes mapping source data onto an ontology/schema, translating it to Resource Description Framework (RDF) format, and subsequently publishing the resulting data through APIs to users and to systems like autonomous drilling controller 230. The schema and subsequently the RDF is constructed based on a hierarchical breakdown of process information. In one embodiment it could have groupings of information by “drilling platform”, “frilling tool”, drilling records”, “drilling hardware”, “drilling software”. Etc. Subsequently each of these higher-level groupings can have sub-groups such as “Bit”, “BHA”. “Fluids”, “RSS” etc. Further granular groupings are also possible where each group is trickled down to smallest possible characterization. In some embodiments, two or more hierarchical structures may be further related to each other through nodes and edges, well established in graph theory.

Organizations store considerable amounts of data in (semi-) structured format, such as in relational databases and CSV files and publish data on the Web in other (semi-) structured formats, such as XML and JSON. Mapping languages and engines may be used to transform, integrate, and feed data into knowledge graphs, while for unstructured data, such as free text and PDF documents, natural language processing and information extraction techniques are required for knowledge graph creation. In the example shown in FIG. 2, structured data stored in structured record database 236 is converted into RDF format before being stored in semantic web 204. In one example approach, as is shown in FIG. 2, data stored in a relational database (RDB) is converted into an RDF format by RDB-to-RDF conversion 222.

Knowledge base 200 may be used for any type of drilling operation that relies on both domain knowledge and past records, such as, for example, drilling operations, formation detection and vibration detection. In one example approach, the semantic web 204 includes information on drilling records. In one example approach, the information on drilling records comes from both structured data 236 (existing databases on drilling records) and unstructured drilling records 234. In one example approach, the drilling record information is stored in semantic web 204.

In the example shown in FIG. 2, LLM 202 receives domain knowledge from one or more domain knowledge sources 232. The domain knowledge is used to interpret and check unstructured records, to respond to user requests and to provide drilling instructions. In some example approaches, LLM 202 learns domain knowledge from books, and other data sources via transfer learning 208. Transfer learning a large language model involves adjusting and adapting a pre-trained model to perform specific tasks or to cater to a particular domain more effectively. The process usually entails training the model further on a smaller, targeted data set that is relevant to the desired task or subject matter.

In the example shown in FIG. 2, LLM 202 receives unstructured records from one or more unstructured record sources 234. In one example approach, LLM 202 extracts structured data from unstructured records via unstructured text interpretation interface 212. The unstructured text is stored as structured data in semantic web 204 via SPARQL Interface 220. In one example approach, LLM 202 includes a SPARQL plug-in 206 used to store the structured data in semantic web 204 via SPARQL interface 220.

In the example shown in FIG. 2, LLM 202 includes a natural language processing API 210. In one such example approach, NLP API 210 receives natural language queries from a user and returns answers to the query retrieved from semantic web 204. In some example approaches, NLP API also receives machine language queries from autonomous drilling controller 230 and returns answers to the query retrieved from semantic web 204 in a machine language.

The knowledge base 200 may be used for automated drilling. For automated drilling, the machine may require the ability to identify the status and performance level of drilling, detect abnormalities, if any, analyze contributing factors to the abnormalities detected and offer suggestions and decisions accordingly. A powerful and scalable knowledge base gathers domain knowledge as well as past drilling records. In some example approaches, the knowledge base is both human and machine readable, and, in some such example approaches, the knowledge base includes logic reasoning (i.e., can derive unknown information from known information via the logics).

In one example approach, knowledge base 200 of FIG. 2 supports drilling automation and natural language inquiries. The knowledge base includes both domain knowledge 232 and past drilling records (such as unstructured drilling records 234 and structured drilling records 236). In one such example approach, the drilling records are stored in both a human readable and machine-readable manner: the records are, in some examples, editable and scalable online (in the sense that there is no black out period during scaling up of the knowledge base).

In one example approach, knowledge base scaling up is performed automatically without human interaction. In one example approach, the knowledge base is able to analyze and provide suggestions to the current drilling operation online.

In one example approach, the knowledge base of FIG. 2 has both an application programming interface (API) for machines, and a natural language interface for humans: the knowledge base is therefore able to suggest optimal operations and respond to queries both from a drilling controller and from site engineers and drillers. In one example approach, knowledge base 200 is aware of the knowledge boundary about past drilling records and does not produce misinformation.

The LLM 202 is used for two tasks: 1) it stores domain knowledge about drilling, and 2) it serves as an interface to the semantic web. Plug-ins or APIs for SPARQL are used in the LLM to hook to the semantic web. The reasons to use LLM as semantic web interface are as follows:
1) LLM 202 is helpful with providing a consistent and flexible interface for the ODs or site controllers, so that they do not need to interact with the semantic web using SPARQL directly.
2) LLM 202 is helpful with inserting data of a new drilling record to the semantic web. Adding new drilling records to the semantic web can be done in several ways. It can be done manually. It can also be done with software that converts structured data to RDF model.

The LLM may also be used to capture unstructured data, as the LLM can capture the information in an unstructured data form, SPARQL the unstructured data accordingly, and execute SPARQL from the Plug in 206 to transfer the information to the semantic web 204. In some example approaches, LLM 202 generates SPARQL for queries and when editing semantic web 204. In some such example approaches, the SPARQL Plug in 206 is used to generate SPARQL to either insert new information from unstructured records into semantic web 204, or to query/edit information as required by the user or by autonomous drilling controller 230 via plug-in 206. Plug-in 206 may, in some example approaches, be a stand-alone plug-in or may be integrated in LLM 202 if LLM 202 is trained in the SPARQL language. In one example approach, LLM 202 may communicate with humans, gather information from unstructured texts such as reports, generate codes such as SPARQL, execute the codes and communicate with other software using plug-ins and APIs.

One example approach for realizing a large language model assisted semantic web knowledge base will be discussed next. First, knowledge base 200 uses transfer learning to obtain an LLM 202 for drilling domain knowledge. There are many LLMs publicly available, both proprietary and open-source, that support transfer learning for domain knowledge using either the built-in service of the LLM, or open-source tools such as LoRA. Since the technology is open and published as part of human knowledge, it is also possible to build an LLM from scratch and train it with the domain knowledge.

Second, knowledge base 200 builds a semantic web 204 for drilling records. A semantic web 204 for drilling records is, in some example approaches, a typical domain ontology semantic web, and may be formed following the standard procedures. The management system for semantic web (similar with relational database management system for relational database) is known as triplestores. There are many available triplestores, both proprietary/commercialized and open-source/free-to-use. A list of representative triplestores may be found at https://www.w3.org/2001/sw/wiki/Category. Some programming languages such as Python also have semantic web relevant packages that support building a light semantic web.

Third, semantic web APIs or LLM plug-ins are enabled to hook semantic web 204 with LLM 202, so that LLM 202 may query and manipulate semantic web data using SPARQL. Many triplestores support API for other software, including LLM 202. Some LLMs 202 also support plug-ins that may hook to other software including semantic web 204.

Fourth, drilling records are added to the semantic web 204. There are programs that convert structured data to RDF model and there are standards that guide this procedure. Some approaches are described in Michel, F., Montagnat, J. and Zucker, C. F., 2014. A survey of ROB to RDF translation approaches and tools (Doctoral dissertation, 135). For unstructured data, such as reports, LLM 202 may be used to gather information from these sources, and to insert the data into the semantic web 204 using SPARQL. Other approaches such as inserting manually or via other AI tools may also be used.

Once the large language model assisted semantic web knowledge base 200 is formed, the LLM 202 serves as the domain knowledge expert and the interface to the semantic web 204. The semantic web 204 contains past drilling records information. The approach overcomes the problems discussed above in integrating LLM into a semantic web, while providing a knowledge base that contains both domain knowledge and past drilling records, where the drilling records are stored in both human and machine-readable manner, and in a way that is editable and scalable online. The knowledge base can scale up automatically without human interaction and can analyze and give suggestions to drilling operations in real-time. In one example approach, LLM 202 includes an artificial intelligence (AI) Chatbot trained with drilling operations domain knowledge.

In one example approach, the knowledge base 200 includes both an application programming interface (API) for machines, and a natural language interface for humans: it is, therefore, able to suggest modifications in operations and to respond to queries to both controller and site engineers and drillers. In some such example approaches, the knowledge base performs logical reasoning, deriving unknown information from known knowledge, is aware of the knowledge boundary about past drilling records, and does not produce misinformation.

Autonomous drilling and drilling performance analysis are used as use cases in the above to illustrate the proposed knowledge base. Notice that any operation that requires both domain knowledge and past records as inputs, and wants to have some level of automation, can benefit from the proposed knowledge base. Therefore, the usage of the knowledge base should not be limited to drilling, but also other applications such as data logging for predictive equipment maintenance, abnormality detection, or pattern recognizing, etc.

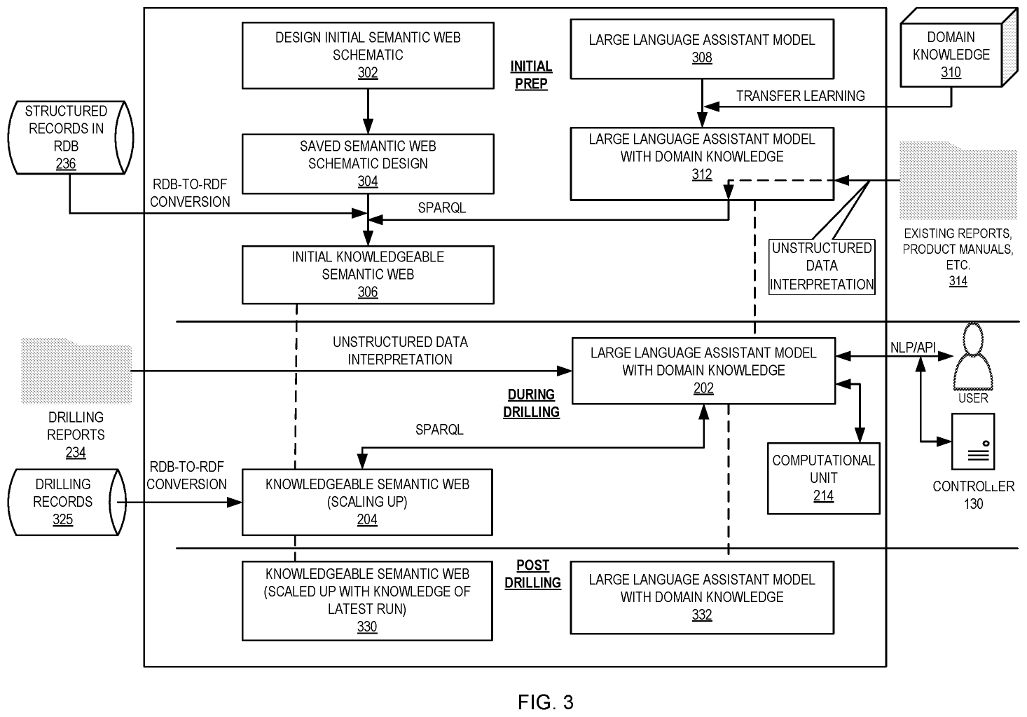

FIG. 3 is a timeline illustrating development of the knowledge base 200 of FIG. 2. In the example approach of FIG. 3, in an initial prep stage, a semantic web 204 is designed at 302 and saved at 304. Existing records in an RDB 305 are converted via RDB-to-RDF conversion and stored in an initial knowledgeable semantic web 306. At the same time, an initial Large Language Assistant model 308 is pre-trained or trained from scratch and then modified via transfer learning using drilling domain knowledge 310 to form a Large Language Assistant Model 312 that includes domain knowledge. Unstructured data (314) from existing documents (such as drilling reports and product manuals) is captured and stored to semantic web 306 via a SPARQL interface. LLM 202 and semantic web 204 are then put online.

As can be seen in FIG. 3, in production (i.e., during drilling phase), LLM 202 continues to process unstructured data (234) from, for instance, drilling reports before saving the data in triples to semantic web 204 via a SPARQL interface. Similarly, new records (such as drilling records) stored in an RDB 325 are converted via RDB-to-RDF conversion and stored in semantic web 204. LLM 202 then responds to natural language and machine-language queries as shown in FIG. 3.

In some example approaches, a computational unit 214 is connected to LLM 202; computational unit 214 provides additional processing power to LLM 202. In one such example approach, computational unit 214 is a collection of functions that boost the computational capability of the knowledge base 200, such as computing the statistical characteristics of variables or filtering signals. In some such example approaches, computational unit 214 communicates with the LLM 202 via API 210. In one example approach, when the LLM 202 requires computational processing of the data after retrieving the data from semantic web 204, LLM 202 triggers the computational unit 214 to do the calculation. Once the data is processed, it may consequently be returned to the user or to the autonomous drilling controller 230, or it may be written back to the semantic web 204 for use in future queries.

When a drilling operation is completed (i.e., post drilling phase), the semantic web 204 is updated with the data from the just completed operation to form semantic web 330 and the LLM 202 is updated with any newly developed domain knowledge to form LLM 332. The process is then repeated with the next drilling operation.

Autonomous drilling and drilling performance identification have been listed as some of the applications of the knowledge base 200. Any operation, however, that relies on both domain knowledge and past records (experience), and that, to some extent, needs to be automated, can benefit from the knowledge base 200. Examples include formation detection and vibration detection and analysis.

It should be noted that, although semantic web is a well-known information storage framework that supports logic inference and SPARQL is a language that may be used to query and manipulate that knowledge base, there is no specific requirements on the choice of knowledge base framework and/or the language to interact with that framework, if it supports logic inference to some extent. Examples include knowledge graph and logic programming systems.

Likewise, there are no specific requirements on the choice of triplestores, meaning that the structure may be replaced by any software that uses an RDF model to save and process data, that supports SPARQL for data query and manipulation, and that supports an API so that other software can interact with semantic web 204 via SPARQL. In one example approach, semantic we 204 uses Turtle/JSON-LD based RDF/RDFS/OWL standards for semantic web recording.

Finally, there are no specific requirements on the choice of LLM models, meaning that the LLM may be replaced, for example, by any artificial intelligence (AI) model that supports natural language processing, which is able to gather information from unstructured data, and that is able to hook to the semantic web.

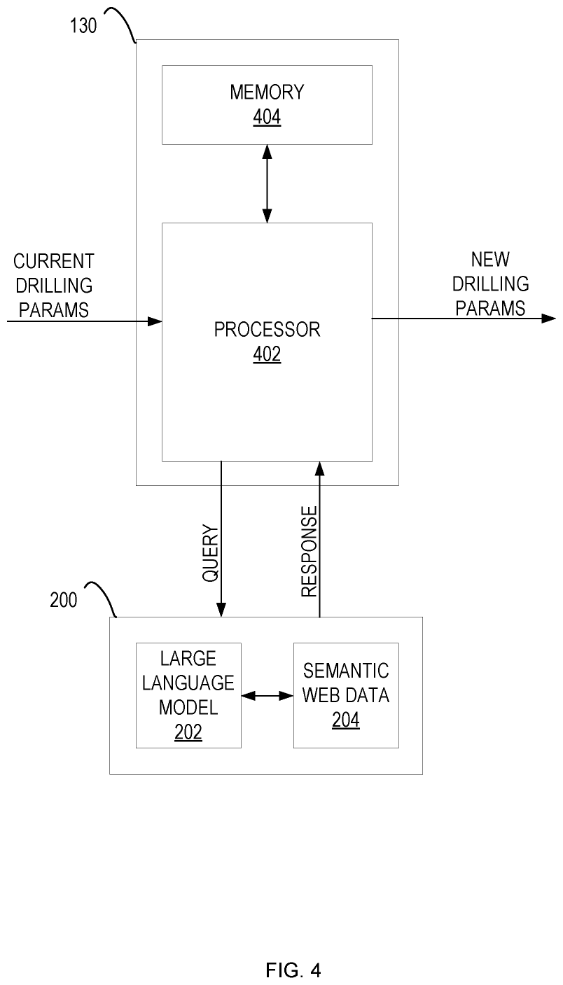

FIG. 4 is a block diagram illustrating an example drilling platform controller 130 connected to a large language model assisted semantic web knowledge base 200. In the example approach of FIG. 4, large language model assisted semantic web knowledge base 200 includes an LLM 202 connected to a semantic web 204. Drilling platform controller 130 includes a processor 402 connected to a memory 404. In one example approach, processor 402 receives current drilling parameters associated with the current drilling operation and determines new drilling parameters by querying large language model assisted semantic web knowledge base 200. In some example approaches, the query is a machine language query that results in a machine language response. In some example approaches, the response to the query may include changes to the current drilling parameters. In operation, the model provides suggested changes in drilling parameters to the drilling operator or to automated drilling controllers in real time.

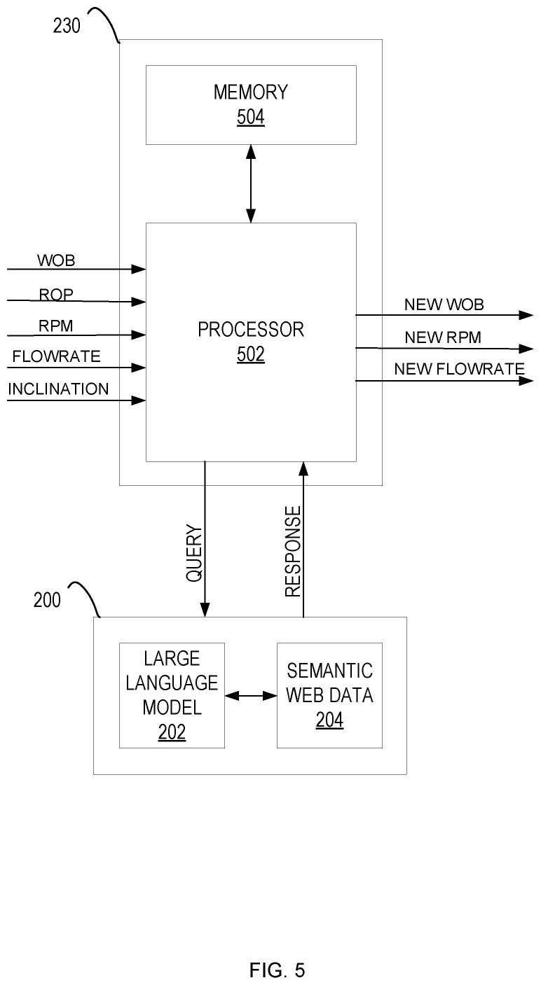

FIG. 5 is a block diagram illustrating an example autonomous drilling controller 230 connected to a large language model assisted semantic web knowledge base 200. In the example approach of FIG. 5, large language model assisted semantic web knowledge base 200 includes an LLM 202 connected to a semantic web 204. Drilling platform controller 130 includes a processor 502 connected to a memory 504. In one example approach, processor 502 receives current drilling parameters associated with the current drilling operation and autonomously determines new drilling parameters by querying large language model assisted semantic web knowledge base 200. In one such example approach, the current drilling parameters include WOB, ROP, RPM, flowrate and inclination while the new drilling parameters include WOB, RPM and flowrate. In some example approaches, the query is a machine language query that results in a machine language response. In some example approaches, the response to the query may include changes to the current drilling parameters. In one such example approach, the current drilling parameters include WOB, ROP, RPM, flowrate and inclination while the new drilling parameters may include changes to one or more of WOB, RPM and flowrate. In operation, the model provides suggested changes in drilling parameters to the drilling operator or to automated drilling controllers in real time.

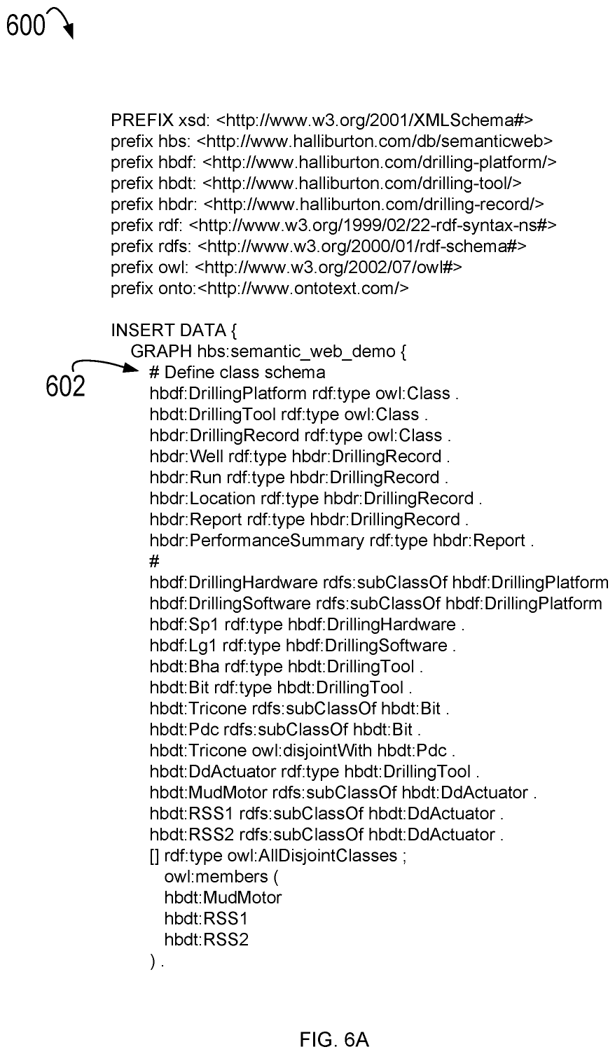

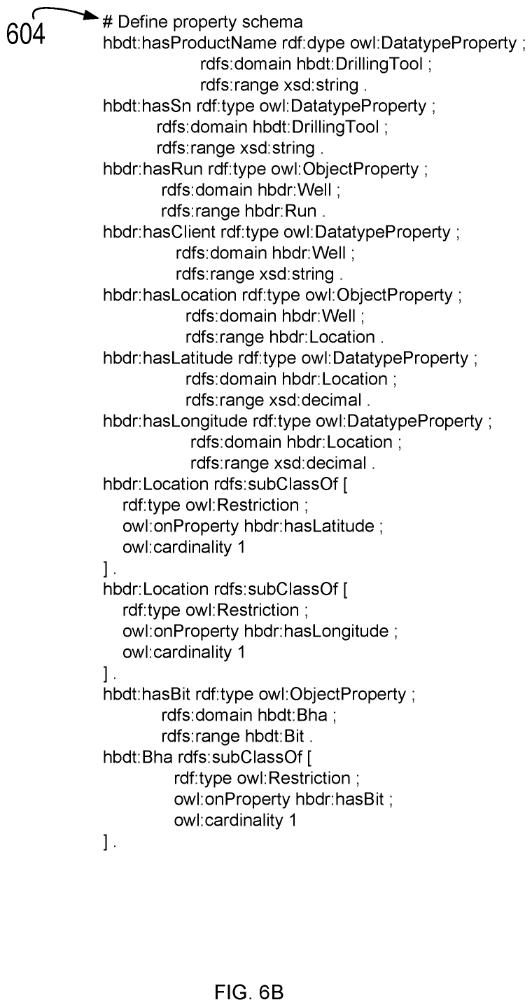

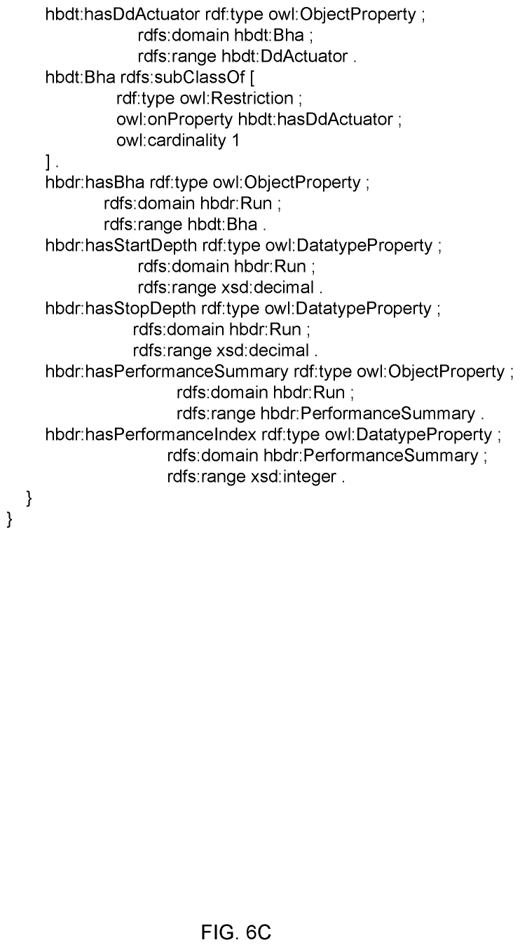

FIGS. 6A-6C illustrate parts of a schematic design of a semantic web such as the semantic webs of FIGS. 2-5. The example shown in FIGS. 6A-6C is a simplified demonstrative example that describes some properties of BHAs and drilling records. In practice, the semantic web schematics design is a more complex representation. In the example shown in FIG. 6, Sp1 is an example directional drilling solution that contains a set of hardware products, and Lg1 is an autonomous drilling platform that comes with monitoring and control programs for drilling. RSS1 and RSS2 are two different rotational steering systems (RSSs) (i.e., directional drilling tools (actuators) with different steering mechanisms). The URIs provided do not exist. They are provided as examples.

The example code 600 shown in FIGS. 6A-6C is illustrative of code that might be used in designing a representative semantic web 204 for drilling records. The code illustrates an example approach for defining (602) class schema and for defining (604) property schema.

In one example approach, semantic web 204 has a high-level hierarchical design that includes three user-defined classes: “DrillingPlatform”, “DrillingTool” and “DrillingRecord.” DrillingPlatform is a collection of “all-in-one” drilling platforms and solutions. Examples include the Sp1 drilling solution and the Lg1 integrated autonomous drilling platform, both shown in FIGS. 6A-6C. In some example approaches, DrillingPlatform is further divided into two subclasses: “DrillingHardware” and “DrillingSoftware”.

In one example approach, “DrillingTool” lists commonly seen tools in drilling. Examples include BHA, bit and steering actuators such as RSS1 and RSS2. In one example approach, “DrillingRecord” includes the media or objects used to store drilling records. Examples include “Well”, an object to store well information such as well location: “Run”, an object to store run information such as the tools used in that run; and “Report” which is an object to a store performance summary of a run.

An example definition of the properties of property schema 604 is provided in FIGS. 6A-6C. In the example shown in FIGS. 6A-6C, Properties are designed with the class, and it is inherited by its components. For example, in the design shown in FIGS. 6A-6C, “hasSn” and “hasProductName” are defined for DrillingTool, indicating that all items defined as a component of DrillingTool, such as Bit and BHA, must have a serial number (SN) and a name.

In one example approach, “DrillingTool” includes three components, “BHA”, “Bit” and “DdActuator” (steering tool). Each BHA 104 contains a bit 114 and a steering tool 109. In one such example approach, bit 114 is further divided into two subclasses, Tricone (i.e., roller cone drill bits) and polycrystalline diamond compact (PDC) drill bits. DdActuator is divided into three subclasses, RSS1, RSS2 and MudMotor. Finally, in DrillingRecord, under Run, each run contains a BHA 104.

In one example approach, “DrillingRecord” includes four components, “Well”, “Run”, “Location” and “Report”. Each well includes client information, location information, and several runs. Each location contains a pair of latitude and longitude. Each run includes the start and stop depth information, a BHA, and a performance summary. The performance summary is a report indicating the performance of the drilling as well as geophysical information obtained during the drilling such as formation information.

In one example approach, data type, domain and range of each property are defined. Restrictions to classes (such as dis-joint of subclasses) and properties (such as the maximum and minimum number of properties a class can have) are enforced. Details are given below through examples.

Consider enforcing data types. For example, the data type of property “hasLatitude” is a numerical number. This is done by defining “hasLatitude” type as follows:
hbdr:hasLatitude rdf:type owl:DatatypeProperty;
   rdfs:domain hbdr:Location;
   rdfs:range xsd:decimal.
      where “rdfs:range xsd:decimal” enforces the range of this property to be of numerical data type.

Consider enforcing domain and range of a property. For example, the property “hasBha” has domain “Run” and range “Bha”. This is enforced as follows:
hbdr:hasBha rdf:type owl:ObjectProperty;
   rdfs:domain hbdr:Run;
   rdfs:range hbdt:Bha.
      where “rdfs:domain hbdr:Run” and “rdfs:range hbdt:Bha” specify the domain and range for “hasBha”, respectively.

Consider enforcing property restrictions. For example, a BHA can have one and only one bit in its “hasBit” property. This is done as follows:

```
hbdt:Bha rdfs:subClassOf [
  rdf:type owl:Restriction ;
  owl:onProperty hbdr:hasBit ;
  owl:cardinality 1
```

where a restriction is added using OWL, indicating that the cardinality of property “hasBit” must be one. Consider another example where it is enforced that the 3 subclasses of DdActuator, RSS1, RSS2 and MudMotor are disjoint. They are steering tools of different mechanisms, and any instant of a steering tool cannot be an instance of more than one of them. This is done by:

```
[ ] rdf:type owl:AllDisjointClasses ;
  owl:members (
  hbdt:MudMotor
  hbdt:RSS1
  hbdt:RSS2
) .
```

which is again, a restriction type defined in OWL.

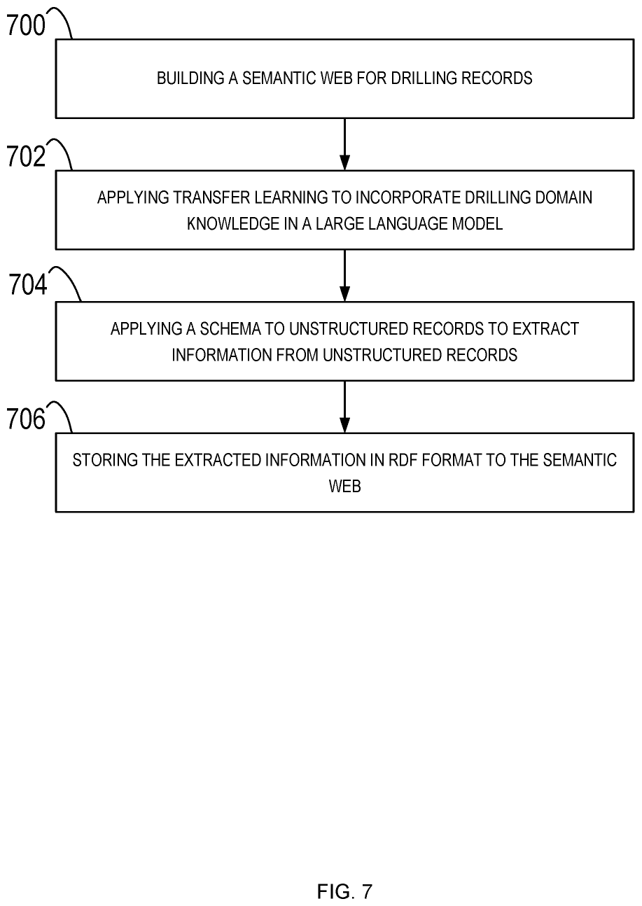

FIG. 7 is a flowchart illustrating a method of controlling a drilling platform controller. In the example approach of FIG. 7, a semantic web for drilling records is constructed (700). In some example approaches, the drilling records in the semantic web are structured drilling records. The structured drilling records include structured drilling records retrieved from, for instance, a database and structured drilling records extracted by an LLM 202 from unstructured sources such as drilling reports and user manuals. An LLM 202 is obtained via transfer learning (702) for drilling domain knowledge and a schema is applied (704) to extract information from unstructured records and to store (706) the extracted information in RDF format to the semantic web 204.

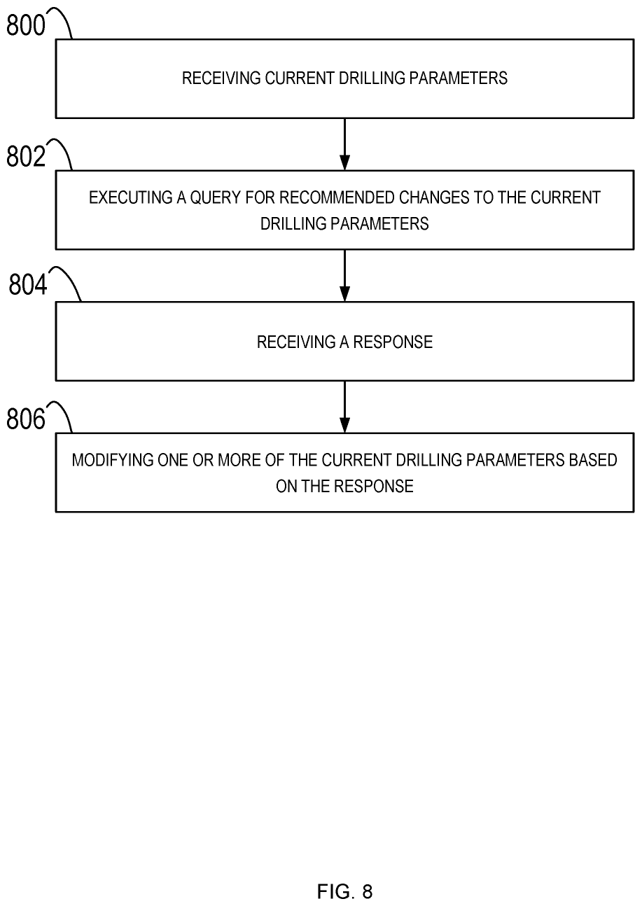

FIG. 8 is a flowchart illustrating a method of guiding a platform drilling controller with an LLM assisted semantic web knowledge base. In the example shown in FIG. 8, an autonomous drilling controller 230 receives (800) current drilling parameters and submits (802) a query to the semantic we via the LLM based on the current drilling parameters. The LLM queries the semantic web and returns (804) a response including an indication of a suggested change in one or more of the current drilling parameters. The autonomous drilling controller 230 modifies (806) one or more of the current drilling parameters based on the response.

Examples of using an LLM assisted semantic web knowledge base 200 are described next. Consider a performance issue where the rate of penetration suddenly drops during the drilling. There are variety of factors that may contribute to this situation, such as a worn-out bit, a hard formation, or required bit cleaning. Conventionally, an experienced DD must be involved to identify the main factors and to make decisions to address the problem, such as to pull out the drill string and replace the bit, to increase weight on bit, or to increase flow rate. In contrast, in a system in which an autonomous drilling controller 230 is paired with an LLM assisted semantic web knowledge base 200, the controller 230 may query past drilling records that used similar BHA and bit design, and that were drilled in nearby regions, which helps to determine the main factors to the problem. The knowledge base 200 uses domain knowledge to evaluate the feasible operations and to find approximately optimal solutions. The system requires no human interaction, and the decision making may be done quickly and accurately with the information queried from the semantic web 204.

In another example, consider a geosteering application where the BHA 104 measures the surrounding geophysical and petrophysical data, and uses that logging data to identify and control the position of BHA 104, keeping the wellbore 118 within a hydrocarbon pay zone. In addition to the measurements, geophysical information obtained from nearby past drillings may be useful for the BHA 104 to identify its position more accurately. With the proposed knowledge base, the autonomous drilling controller 230 may query for geophysical and petrophysical data from nearby drilling sites and retrieve the formation and hydrocarbon characteristics. The retrieved formation and hydrocarbon characteristics may be matched with the petrophysical measurements of the current drilling, thus identifying the relative location of the hydrocarbon pay zone from the wellbore 118 more accurately. With better position identification, elevated levels of autonomous control may be implemented.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A large language model (LLM) assisted semantic web knowledge base, comprising:
an LLM trained with drilling operations domain knowledge;
a semantic web connected to the LLM, and
a converter, wherein the converter retrieves structured drilling records, converts the structured drilling records into Resource Description Framework (RDF) format and stores the RDF formatted drilling records to the semantic web, and
wherein the LLM interprets unstructured data and saves the interpreted unstructured data in RDF format to the semantic web.

2. The LLM assisted semantic web knowledge base of claim 1, wherein the LLM includes a SPARQL plug-in, the SPARQL plug-in configured to generate SPARQL to insert new information from unstructured records into the semantic web.

3. The LLM assisted semantic web knowledge base of claim 2, wherein generating SPARQL to insert new information from unstructured records into the semantic web includes applying a schema to the unstructured records.

4. The LLM assisted semantic web knowledge base of claim 1, wherein the LLM includes a SPARQL plug-in, the SPARQL plug-in configured to generate SPARQL to query the semantic web.

5. The LLM assisted semantic web knowledge base of claim 1, wherein the LLM includes a SPARQL plug-in, the SPARQL plug-in configured to generate SPARQL to edit the semantic web under user control.

6. The LLM assisted semantic web knowledge base of claim 1, wherein the converter is a Relational Database Service (RDS) to RDF converter.

7. The LLM assisted semantic web knowledge base of claim 1, wherein the LLM is includes domain knowledge obtained from transfer learning of domain knowledge sources.

8. A method, comprising:
building a semantic web for drilling records, wherein building includes converting drilling records retrieved from a database into a Resource Description Framework (RDF) format and storing the RDF formatted drilling records in the semantic web;
applying transfer learning to drilling domain knowledge to obtain a large language model (LLM) with drilling domain knowledge, the LLM configured to query the semantic web and to manipulate RDF formatted data within the semantic web;
applying a schema to unstructured records to extract information from unstructured records; and
storing the extracted information in RDF format to the semantic web.

9. The method of claim 8, further comprising:
building a computation model for drilling records, wherein building includes creating a computational framework of algorithms, statistics, and machine learning networks that compute answer products from unstructured or RDF formatted drilling records based on prompts received through the LLM;
storing information based on the answer products in the semantic web with appropriate classification.

10. The method of claim 8, wherein the unstructured records include drilling reports and product manuals.

11. The method of claim 8, wherein the method further includes:
receiving a query at the LLM;
querying the semantic web based on the query received by the LLM; and
delivering a response to one or more of a user or a machine based on the semantic web query.

12. The method of claim 11, wherein the received query is a natural language query, and the response is a natural language response.

13. The method of claim 11, wherein the received query is a machine language query, and the response is a machine language response.

14. The method of claim 11, wherein querying the semantic web based on the query received by the LLM includes generating a SPARQL query from the query received by the LLM.

15. The method of claim 9, wherein the method further includes:
receiving an edit at the LLM; and
editing the semantic web based on the edit received by the LLM.

16. The method of claim 9, wherein the database is a relational database and wherein converting drilling records includes applying a Relational Database Service (RDS) to RDF converter to the drilling records.

17. A drilling platform controller, comprising:
a processor; and
a memory connected to the processor, the memory including instructions that, when executed by the processor, cause the processor to:
receive current drilling parameters;
query a large language model (LLM) assisted semantic web knowledge base based on the current drilling parameters, the LLM assisted semantic web knowledge base including an LLM trained with drilling operations domain knowledge, a semantic web connected to the LLM, and a converter, wherein the converter retrieves structured drilling records from a database, converts the structured drilling records into Resource Description Framework (RDF) format and stores the RDF formatted drilling records to the semantic web,
receive a response from the LLM; and
change one or more of the current drilling parameters based on the response.

18. The drilling platform controller of claim 17, wherein the memory further includes instructions that, when executed by the processor, cause the processor to submit an edit to the semantic web through the LLM.

19. The drilling platform controller of claim 17, wherein changing one or more of the current drilling parameters based on the response includes changing one or more of Weight on Bit (WOB), Rate of Penetration (ROP), RPM or flowrate.

20. The drilling platform controller of claim 17, wherein the current drilling parameters include one or more of WOB, ROP, RPM, flowrate or inclination.
